(19) United States
(12) Patent Application Publication
(10) Pub. No.: US 2006/0178497 A1
(43) Pub. Date: Aug. 10, 2006

(54) Implantable biomedical devices including biocompatible polyurethanes

(75) Inventors: Matthew R. Gevaert, Central, SC (US); Martine LaBerge, Seneca, SC (US); Jianrong Feng, Burlington (CA)

Correspondence Address: DORITY & MANNING, P.A., POST OFFICE BOX 1449, GREENVILLE, SC, 29602-1449, US

(73) Assignee: Clemson University and Thordon Bearings, Inc.

(21) Appl. No.: 11/051,992

(22) Filed: Feb. 4, 2005

(51) Int. Cl. C08G 18/00

(52) U.S. Cl. 528/44

(57) ABSTRACT

Disclosed are implantable devices that include biocompatible polyurethane materials. In particular, the disclosed polyurethane materials can maintain desired elastomeric characteristics while exhibiting thermoset-like behavior and can exhibit improved characteristics so as to be suitable in load-bearing applications. For example, the disclosed polyurethane materials can be suitable for use in artificial joints, including total joint replacement applications. The disclosed polyurethane materials include biocompatible cross-linking agents as chain extenders, more particularly chain extenders comprising a terminal group capable of side reactions and further comprising an electron withdrawing group immediately adjacent the terminal group. In addition, the reaction materials and conditions can be selected to encourage intermediate levels of cross-linking without the use of traditional cross-linking trifunctional reagents. In addition, the chain extenders can also include substantially inflexible moieties so as to increase the rigidity of the product polyurethanes.

### BACKGROUND OF THE INVENTION

Polyurethanes and polyureas are general terms covering a huge group of materials that can be manufactured to produce a range of products having properties from soft and flexible to hard and rigid. The characteristic urethane linkage of a polyurethane is formed by the reaction of a di-isocyanate with a molecule containing an acidic hydrogen, often a polyol. In general, polyurethanes can be conceptualized as block copolymers comprised of alternating urethane and polyol segments. The urethane and polyol segments are conveniently referred to as hard and soft segments, respectively, because they are typically below (hard) and above (soft) their glass transition temperature (T_{g}) under the environmental conditions in which the products are normally used. Optionally, polyurethanes can also include a chain extender, which, in the past, has typically been a short-chain diol that can contribute to the structure of hard segments in the product materials. The nature of the hard segment and interactions between hard segments primarily determine physical properties of the final polyurethane product such as tensile strength, hardness, and tear resistance, while the nature of the soft segment primarily determines glass transition temperature (T_{g}) and elastic properties of the product.

Traditionally, implantable polymeric devices designed for orthopedic applications, and in particular load-bearing applications, have been formed of polyethylenes, and primarily ultra-high molecular weight polyethylenes (UHMWPE). For example, UHMWPE joint replacement implants are currently the most common commercially available joint replacement materials. Problems still exist with these materials, however, for example, UHMWPE materials have shown low fatigue strength and little shock absorption capability. In addition, submicron particles of UHMWPE, which can be released due to abrasive wear of the materials, are believed to migrate into the joint space and stimulate an immune response, which can ultimately lead to osteolysis and bone loss in implant recipients.

Polyurethanes have been used in the past in biomedical applications. Typically, however, polyurethanes utilized for biomedical applications have been soft, flexible, uncrosslinked thermoplastic materials synthesized using diol chain extenders. For example, polyurethanes of this sort have been found in implantable devices including pace maker leads, catheters, and artificial hearts.

Despite advances in addressing the needs for longer lasting and better performing biocompatible, rigid elastomeric materials, polyurethanes have not reached their potential for use in implantable devices, and particularly in load-bearing applications. Larger amount of liquid absorption is expected in polyurethanes than in many other polymers, as is generally known in the art. Changes of many key mechanical properties due to liquid absorption are more pronounced in polyurethanes than in many other polymers, and material design concepts based on the properties of the polyurethane in the dry state which incorporate comparisons to polymers such as polyethylene may lead to poor performance or failures under actual in vivo conditions. In addition, verification of performances under simulated testing conditions has not been an area of work previously examined, which may disclose problems with the design concepts of many previously known materials for the targeted applications. For instance, properties of existing biocompatible polyurethane materials are often only evaluated in dry conditions, and thus may be irrelevant for actual in vivo applications involving water/fluid immersion, where they may not meet all the property requirements in demanding applications such as knee and hip joints.

The use of such polyurethanes as load-bearing materials has been reported or proposed for orthopedic applications but apparently has not gained commercial acceptance.

As one example, bearings have been proposed to include a soft polyurethane material as the orthopedic bearing surface in artificial joint applications (see, for example, U.S. Pat. No. 5,879,387 to Jones, et al.). The soft polyurethane bearing surfaces of these designs generally interface with a much stiffer material that can form, for instance, the acetabular cup of an artificial joint. The interface is generally achieved through utilization of bonded layers of increasing modulus.

As another example, Townley, et al. (U.S. Pat. No. 6,302,916) discloses a monolithic polyurethane-containing component for load bearing medical use. The materials comprise the reaction product of an isocyanate and an organic compound having at least two active hydrogen moieties. The polyurethane material of Townley, et al. can also include a chain extender. Specifically, possible chain extenders are described as short chain diols, generally of from three to twelve or so carbons per carbon chain, and also include certain primary and/or secondary amines, alkanolamines, and thiols.

In the past, harder biocompatible polyurethanes have been typically achieved via reaction strategies similar to that of soft polyurethanes, but with the utilization of a lower molecular weight soft segment or reagents designed to increase the hard segment content (e.g. short chain extenders) and/or modify the hard segment properties (e.g. substitution of aromatic hard segments for aliphatic hard segments). Typical hard biocompatible polyurethanes are normally still thermoplastics, however, and cross-linking and thermosetting characteristics, when desired, have been achieved through small amounts of triol chain extenders. This strategy has the disadvantage that these crosslinked materials, while exhibiting somewhat higher hardness, generally have poorer physical properties than the linear polyurethanes due to disruption of the microphase separation between hard and soft segments.

Diols have typically been the preferred chain extender in biomedical polyurethanes in the past primarily because the reactivity of diols is slow enough to provide suitable reaction time (or pot life) to enable thorough, uniform mixing, and the ability to manipulate the mixture (for example to extrude or cast the mixture) prior to full polymerization.

Diamines have also been considered as possible chain extenders in forming biomedical polyurethanes in the past but have generally been found unfavorable because they react too rapidly and vigorously with isocyanates and also set rapidly, so that their use has been generally limited to one-step reaction injection molding processes. In addition, required reaction temperatures utilizing diamine chain extenders has been reported as low (generally less than about 50° C.) in order to limit side reactions. Toxicity of many diamines has also kept these materials from being utilized in biomedical applications, in particular as known diol chain extenders tend to be much less toxic than many possible diamine chain extenders.

In the past, chain extenders with tri- or higher-valent terminal groups have been considered too reactive to be utilized in forming biocompatible devices, as final cure of the polymer could occur before thorough mixing or molding processes could be completed.

Despite many advances in addressing the needs for longer lasting and better performing biocompatible, rigid, elastomeric materials, polyurethanes have not been highly valued or utilized in certain biomedical applications and particularly in load-bearing applications and thus, there remains room for variation and improvement within the art.

It is the inventors' belief that the disclosed materials, based on different molecular design and property criteria, can provide improved implantable polyurethane materials displaying improved in vivo performance. In particular, the presently disclosed materials address the above and other problems with existing biomedical polyurethanes.

### SUMMARY OF THE INVENTION

The present invention is generally directed to implantable biomedical devices that include biocompatible, elastomeric polyurethanes. In one embodiment, the devices of the present invention can include elastomeric polyurethanes that are the polymerization reaction product of a di-isocyanate monomer, a soft segment monomer, and a chain extender. The chain extenders of the present invention can be selected based upon their potential biocompatibility as well as on their ability to favorably affect the reaction dynamics and properties of the final polymer. In particular, the chain extenders of the present invention include a terminal group capable of undergoing side reactions such as chemical cross linking. For example, in one embodiment, the chain extender can be a diamine with favorable biocompatibility.

The chain extenders of the current invention also incorporate an electron-withdrawing group immediately adjacent to the terminal group, in order to reduce reactivity of the chain extender through electron effects. This appears to reduce the overall reactivity of the chain extender and provide a workable pot life during polymerization that can allow thorough mixing and manipulation of the materials prior to final cure.

The chain extenders of the current invention can also include one or more substantially inflexible groups. For example, the chain extender can include one or more inflexible aromatic groups. In one embodiment, the chain extender can include an aromatic group immediately adjacent the terminal group, and thus a single aromatic group can function as both the electron withdrawing group and the substantially inflexible group. In one embodiment, the chain extender can be dimethylthiotoluene diamine.

In one embodiment, the chain extender can include two or more substantially inflexible groups along the segment. For example, the chain extender can include two substantially inflexible groups that can be linked with a C1-C8 substituted or unsubstituted aliphatic chain. For instance, in one embodiment, the chain extender can include an ester of p-aminobenzoic acid such as trimethylene glycol di-p-aminobenzoate.

In one embodiment, a substantially inflexible chain extender as herein described can form strong intra- and/or inter-molecular attractions (such as hydrogen bonding, for example) with other segments of the material that can further improve the strength, rigidity, and toughness of the polyurethane.

Generally, the polyurethanes of the invention can be formed of any suitable di-isocyanate and any suitable soft segment molecule. For example, the di-isocyanate can be aliphatic or aromatic. In one embodiment, the soft segment molecule can be a diol. In addition, the soft segment can include any linking bonds along the soft segment backbone as is generally known in the art. For example, in various embodiments, the soft segment can include polycarbonate, dimer acid, polyester, or polyether linking segments.

In one embodiment, the biocompatible polyurethanes of the invention can have the following general structure: 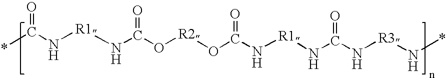
wherein

the aromatic or aliphatic residue of the di-isocyanate comprises R1,

the residue of the soft segment comprises R2, and

the residue of the chain extender comprises R3.

The disclosed biocompatible materials can be utilized in many different implantable devices. For example, the disclosed materials can be used in forming orthopedic devices, vascular devices, shunts, catheters, or reconstructive devices. In one particular embodiment, the disclosed materials can be used in forming artificial joints, and in particular the load-bearing portions of artificial joints, such as hip replacement joints (or components thereof such as the acetabular cup), knee replacement joints (or components thereof such as the tibial plateau) and spinal implants (such as artificial intervertebral implants). Accordingly, in one embodiment, the disclosed polyurethanes can be harder polyurethanes, for example, in one embodiment the disclosed materials can preferably have a Shore D hardness greater than about 60D.

### BRIEF DESCRIPTION OF THE FIGURES

A full and enabling disclosure of the present invention, including the best mode thereof, to one of ordinary skill in the art, is set forth more particularly in the remainder of the specification, including reference to the accompanying figures in which:

FIG. 1 illustrates a mold utilized to form the dumbbell-shaped samples of the polyurethane materials examined in the example section;

FIGS. 2A and 2B are visual images showing damage tracks formed on samples during wear testing;

FIGS. 3A-3E are SEM images of damage tracks on an UHMWPE sample;

FIGS. 4A-4D are SEM images of damage tracks on a filler-free polyurethane sample; and

FIG. 5 is a schematic representation of a testing apparatus utilized in the example section.

Repeat use of reference characters in the present specification and drawings is intended to represent the same or analogous features or elements of the present invention.

### DETAILED DESCRIPTION OF THE INVENTION

Reference will now be made in detail to various embodiments of the invention, one or more examples of which are set forth below. Each embodiment is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used in another embodiment to yield a still further embodiment. Thus, it is intended that the present invention cover such modifications and variations as come within the scope of the appended claims and their equivalents.

The present invention is directed to implantable biocompatible devices that can be either completely formed of biocompatible polyurethanes or incorporate a component formed of biocompatible polyurethanes. More particularly, the disclosed materials can be more suitable than previously known polyurethane materials for utilization in expected in vivo conditions. In addition, the polyurethanes of the disclosed devices can display more thermoset-like characteristics than previously known biomedical polyurethanes. For instance, in one particular embodiment, the disclosed materials can be harder than previously known biocompatible polyurethanes.

In general, any isocyanate as is generally acceptable in forming a biocompatible polyurethane can be utilized in forming the disclosed materials. Suitable isocyanates can be broadly grouped into those in which the isocyanate group (NCO) is bonded to an aromatic ring (aromatic isocyanates) and those in which the isocyanate group is bonded to a saturated carbon atom (aliphatic isocyanates).

In certain embodiments, aromatic isocyanates can be utilized. Although reactivity can be subject to the effect of catalysts and of steric hindrance, aromatic isocyanates normally have much higher reactivity than do aliphatic isocyanates, in particular as the electron withdrawing effect of an aromatic ring decreases electron density of the isocyanate group's carbon, making it more prone to nucleophilic attack. In addition, due to the ordered packing associated with aromatic rings concentrated in hard segment domains, polyurethanes including aromatic isocyanates can show improved mechanical properties such as hardness and can have higher melting temperatures than materials formed with aliphatic hard segments. In addition, aromatic isocyanates are typically less expensive than aliphatic isocyanates. As such, in association with the chemical effects noted above, in certain embodiments of the present invention, aromatic isocyanates may be preferred. This is not a requirement of the present invention, however, and in some embodiments, aliphatic isocyanates may be preferred.

A non-limiting exemplary list of aromatic di-isocyanates suitable for the present invention include toluene di-isocyanate (TDI) and methylene bis(phenyl isocyanate), (MDI) such as 4,4′- methylene bis(phenyl isocyanate), For example, TDI can be utilized as commonly obtainable as a mixture of 2 isomers in an approximately 4 (2,4 substitution) to 1 (2,6 substitution) ratio. In general, an isomeric mixture need not be separated before formation of the disclosed polyurethane materials

Other exemplary isocyanates suitable for inclusion in the materials of the present invention can include 1,6-hexamethylene di-isocyanate (HDI), 4,4′-methylene bis(cyclohexyl isocyanate) (HMDI), isophorene di-isocyanate (IPDI), para-phenylene di-isocyanate (PPDI), 1,5-naphthalene di-isocyanate (NDI), 1,4-cyclohexyl di-isocyanate (CHDI), 4,4′-methylene bis(phenyl isocyanate), and other MDI-family members such as a mixture of 4,4′- and 2,4′-MDI or mixtures of 4,4′-, 2,4′- and 2,2′-MDI, substituted MDIs (CM3, OCM3, etc.) including poly(methylene)poly(phenylene) polyisocyanate (PMDI) and carbodiimide-modified MDI, MDI-containing quasi-prepolymers, polymeric MDI with NCO-functionality of about 2.1-3.0, adducts of isocyanates to polyols including trimethylolpropene plus TDI, trimerization products of isocyanates, biuret adduct of 1,6-MDI, and the like.

According to one embodiment of the present invention, a suitable di-isocyanate can be combined with a molecule containing terminal acidic hydrogens to form a polyurethane pre-polymer in the first step of a two-step formation process. Although the present discussion of suitable soft segments is generally directed to diols, it should be understood that suitable soft segment monomers of the present invention also encompass suitable substitution for, or augmentation of, the disclosed diols as is generally known in the art. For instance, the soft segment monomers can include suitably stable amino and/or mercapto-containing groups. Moreover, suitable groups may serve in the soft segments of the polyurethanes with or without the disclosed polyols as the acidic hydrogen-containing compound.

In one embodiment, polyol soft segments of the disclosed polyurethanes can be linear chains having only the two terminal hydroxyl reactive groups and therefore can be incorporated into the polyurethane directly as such.

In various embodiments of the invention, and depending upon the specific characteristics desired for the product polyurethanes, the soft segment monomer can include various groups as are generally known in the art. For example, the soft segment monomers can include polyester polyols, dimer acid polyols, polycarbonate polyols, polyether polyols, and polyolefin polyols. The disclosed polyurethane materials can utilize any biocompatible soft segment monomer, however, and are not limited to polyether and the various polyester-based diols. In addition, other materials as are generally known in the art can also be incorporated into the materials. For example, the soft segment monomers used in forming the disclosed polyurethanes can include the incorporation of silicone in conjunction with or as a replacement for ether groups, as is generally known in the art.

Other chemistries in addition to siloxanes can also be utilized in the disclosed materials. For example, soft segments as described above can be combined with other secondary materials to produce co-soft segments. For instance, the disclosed materials can include co-soft segments such as polyethylene oxide co-soft segments and hydrocarbon co-soft segments. In one embodiment, a polyether polyol soft segment monomer can be modified and/or combined with polysiloxane, fluorocarbon end groups, or polyethylene oxide, as is generally known in the art. Such modifications and combination can be utilized, for example, to prevent environmental stress cracking as has been associated with the use of polyether diols in forming biocompatible polyurethane materials in the past.

In general, any suitable method of contact and reaction between the hard segment isocyanate and the soft segment polyol can be utilized in forming the prepolymer. For example, in one embodiment, the soft-segment monomer can be added to the di-isocyanate monomer slowly, such as over a period of several hours, under blanket of inert gas in order to form the prepolymer.

The polyurethane materials of the disclosed invention also include chain extenders that can, in a two-step formation process, be combined with the isocyanate-terminated prepolymers prepared from the above-described materials to form the high molecular weight polyurethanes of the present invention. For example, the disclosed polyurethane materials can in a preferred range include between about 10% and about 40% by weight of a chain extender as herein described. More specifically, in a more preferred range, the polyurethanes used in forming the disclosed devices include between about 15% and about 35% by weight of a chain extender, and in an even more preferred range between about 20% and about 30% by weight. In one particular embodiment, the disclosed polyurethane materials include about 25% by weight of a chain extender as herein described.

In one embodiment, the polyurethane can have a general formula of: 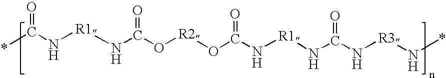
wherein

the aromatic or aliphatic residue of the di-isocyanate comprises R1,

the residue of the soft segment comprises R2, and

the residue of the chain extender comprises R3.

It should be understood that while the above structure can generally illustrate the class of polymer materials and reaction reagents and steps used, in one embodiment, due to the many variations used in forming polyurethane materials, there may be no simple molecular structure that can describe and cover all the material types and changes in full accuracy and details. For instance, the specific structure shown above may not directly show such variations including the use of multi-valence terminal groups, the presence of crosslinking, and the number of all reagents and steps used for the reactions any or all of which can be encompassed in the present invention. The above structure has been used to demonstrate all the key concepts of forming the polyurethane materials, such as the formation of urethane and urea bonds, the one-step and multi-step reaction processes, and the basic atomic/molecular arrangements. As such, it should be understood that the disclosed polyurethane materials are not limited to the above structure.

In accord with the present invention, the chain extenders used in forming the disclosed polyurethanes comprise agents that promote side reactions between polymer segments. More specifically, the chain extenders of the present invention include a terminal group including a reactive atom of tri- or higher valency. Thus, this reactive atom can react not only with the prepolymer in the polymerization reaction, but can also be involved in side reactions, which can form additional bonds between polymer segments. In one embodiment, the terminal group can be an amine. In one particular embodiment, the chain extender can be a diamine. While not wishing to be bound by any particular theory, it is believed that through utilization of the disclosed chain extenders, the wear characteristics and tribology characteristics of the product polyurethane materials of the implantable devices including the polyurethane materials can be enhanced and can be particularly enhanced under expected in vivo conditions.

In the present invention, the chain extenders also include an electron-withdrawing group immediately adjacent to the reactive terminal moiety. The electron-withdrawing group can decrease the overall reactivity of the terminal group, thus allowing the use of chain extenders with tri- or higher-valent terminal groups, contrary to teachings of the past. As such, the rate of the polymerization and side reactions during formation and cure of the polyurethanes can be slowed somewhat, allowing good mixing between the prepolymer and the chain extender as well as any molding or shaping of the material before the polymer is finally cured.

An electron-withdrawing group can include, for example, a carbon that by resonance effects can stabilize a partial positive charge on the tri- or higher-valency atom of the terminal group. For example, in one embodiment, a terminal amine moiety can be immediately adjacent to, i.e., directly substituted onto, an aromatic ring. In another embodiment, the electron-withdrawing group can be an aliphatic chain of at least three carbons with alternating carbon-carbon double bonds along the chain or optionally moieties containing carbon-oxygen double bonds. Other electron withdrawing groups as are generally known in the art can also be utilized.

In one embodiment, the chain extenders of the present invention can also include substantially inflexible groups. According to the present disclosure, the term ‘substantially inflexible’ is herein defined to mean that the group, following polymerization, does not exhibit substantial molecular rotation. For example, the chain extender can include one or more aromatic groups that can resist molecular rotation following polymerization. Other substantially inflexible groups that can be included on the chain extenders that can exhibit limited rotation following polymerization can include other cyclic groups, unsaturated carbon chains of at least three carbons, or segment lengths that form quasi-cyclic groups due to hydrogen bonding between nonadjacent atoms on the segment.

In one particular embodiment of the present invention, the chain extender can include an aromatic moiety immediately adjacent to the tri- or higher-valent terminal group. Aromatic moieties can not only function as electron withdrawing groups and are substantially inflexible following polymerization, but they can also increase chain interaction and entanglement in the polymer. In particular, the presence of aromatic rings in the chain extenders can provide for interaction with other aromatic rings on other chains in a known ‘stacking’ fashion. This effect is believed to increase interactions between hard segments, and thus further improve product characteristics such as rigidity and hardness.

It is believed that the chain extenders of the present invention can provide for both increased side reactions within the hard segment and increased chain entanglement within the product polymer without the expected overly fast polymerization and cure of the materials. As a result, the product polymers are believed to have more thermoset-like characteristics, as compared to biomedical polyurethanes of the past. For instance, the polyurethanes of the present invention, while having product characteristics in certain embodiments such as increased hardness and increased elastic modulus due to the increased number of side reactions, can still maintain the elastomeric qualities (e.g., molecular motion allowing stretch) desired for use in biomedical applications such as high load bearing applications.

According to one embodiment, the chain extenders can include a single aromatic group directly substituted with at least two amine groups in any fashion. For example, the chain extender can include a single aromatic ring with two o-, m-, or p-substituted amine groups. Optionally, the aromatic ring can be substituted with other less reactive groups as well, in addition to the reactive terminal groups.

In one particular embodiment, the aromatic diamine dimethylthiotoluene diamine can be used as the chain extender. This particular chain extender exhibits very few safety concerns and is commercially available as an 80%/20% mixture of the 2-4 isomer (3,5-dimethylthio-2,4-toluene diamine), and the 2-6 isomer (3,5-dimethylthio-2,4-toluene diamine) under the trade name Ethacure® 300 from Albemarle Corp. of Baton Rouge, La., and is illustrated below.

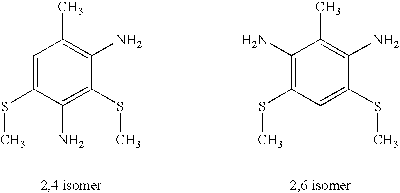

The aromatic chain extenders can optionally be larger monomers. For example, in one embodiment, the chain extenders can include two or more substantially inflexible groups as well as a suitable linking agent, such as an aliphatic linking chain, for example, between the substantially inflexible groups. For example, in one particular embodiment, the chain extender can include two or more substantially inflexible aromatic groups linked with a C1-C8 substituted or unsubstituted aliphatic chain. Other linking groups between the substantially inflexible groups can include, for example, heteroatom substitution within chains.

In one embodiment, the chain extender of the present invention can include esters of p-aminobenzoic acid, which have long been in commercial use as local anesthetics. For example, in one embodiment, the di-ester of trimethylene glycol and p-aminobenzoic acid, trimethylene glycol di-p-aminobenzoate, illustrated below, and available under the trade name Versalink® 740M from Air Products Corporation of Allentown, Pa., can be used.

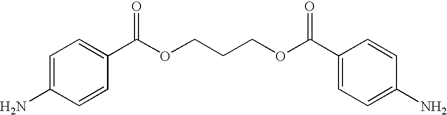

Optionally, combinations of two or more chain extenders may be utilized in the present invention. For example, in certain embodiments, one or more of the disclosed chain extenders may be combined with previously known aliphatic diol or diamine chain extenders such as those utilized in previously known biocompatible polyurethanes.

For example, in one embodiment, one or more of the chain extenders of the present invention can comprise at least about 50% by weight of the total amount of chain extenders utilized in the polymerization process. The second, less reactive type of chain extender may be blended with the other primary chain extender(s) and reacted with the prepolymer in the second reaction step, or it may be blended and reacted in the first step in which the prepolymer is formed. In one embodiment, a second chain extender can be combined with soft segment polyol and reacted with excess di-isocyanates to form a multi-component prepolymer.

In instances in which the disclosed chain extenders may be combined with previously known diol chain extenders, following polymerization of the isocyanate-terminated prepolymer with the combination of chain extenders, the resulting polyurethane may comprise a mixture of polyurethanes some with the general formula of: 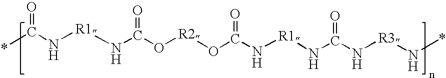
and some with the general formula of: 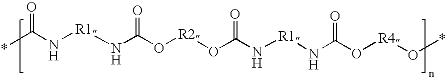
in each case wherein

the aromatic or aliphatic residue of the di-isocyanate comprises R1,

the residue of the soft segment comprises R2,

the residue of the diamine chain extender comprises R3, and

the residue of the diol chain extender comprises R4.

According to the present invention, elastomeric polyurethanes are disclosed suitable for use in implantable biomedical devices. In one particular embodiment, the disclosed polyurethane materials can be hard, elastomeric polyurethanes (HEPU). For example, in one embodiment, the disclosed materials can be advantageously utilized in load-bearing biomedical applications. For instance, the disclosed materials can be utilized in load-bearing artificial joints such as may be utilized in total joint replacement procedures, including for example, artificial knee joints and artificial hip joints. In one particular embodiment, the entire acetabular cup of an artificial hip joint can be formed of the disclosed polyurethane materials. That is, the polyurethane material can not only form the articulation surface of the acetabular cup, but in this particular embodiment, the polyurethane material of the present invention need not be layered with a harder backing material when forming the acetabular cup. In another embodiment, the tibial plateau of an artificial knee joint can be formed of the disclosed polyurethane materials. In another embodiment, the disclosed materials can be utilized in formation of spinal implants. For example, the disclosed materials can be utilized in forming biocompatible intervertebral implants, such as for interverbral disc replacement.

The disclosed materials can be utilized in other biomedical applications as well, in addition to load-bearing implantable devices. For example, the disclosed materials can be advantageously utilized in forming vascular devices, such as artificial heart valves, left ventricular assist devices (LVAD), implantable artificial hearts, vascular stents, and the like. In another embodiment, the disclosed materials can be utilized in forming reconstructive devices, including structural supports for hard tissue replacement or non-structural void-filling replacement of soft tissue. In other embodiments, the devices of the disclosed invention can include shunts, catheters, pace maker leads, and the like. In particular, it should be understood that while the discussion below is primarily directed to embodiments of the invention in which hard polyurethanes (i.e., having a Shore D hardness greater than about 60) can be formed, the invention is not limited to devices incorporating these hard polyurethanes and in other embodiments, the polyurethanes utilized in the devices of the invention can be softer. In particular, in other embodiments of the invention, softer polyurethanes can be formed of the disclosed materials through methods and practices generally known to one of ordinary skill in the art, including, for instance, the relative proportion of the disclosed soft segments, hard segments, and chain extenders to each other in the final polyurethane formulation.

The polyurethane materials of the present invention are biocompatible and are also safe for use in forming the biocompatible implantable devices of the present invention. In particular, the materials can be polymerized from monomers that have been considered and found acceptable for use in biomedical applications. Monomer toxicity has been little considered in the development of biocompatible polyurethanes in the past. In the presently disclosed biocompatible polyurethanes, the hard segment components, the soft segment components, and the chain extenders can all be materials that have been approved for utilization in applications associated with biological use or that possess no known health concern in polymerized form.

More particularly, the chain extenders of the present invention can exhibit non-toxic behavior in the polymerized state. In addition, the chain extenders can possess no obvious toxic concerns in the monomer state. For example, in one embodiment, the chain extenders or the polyurethane products incorporating the chain extenders possess one and/or all of the following characteristics:
a non-irritant in FDA approved Primary Skin Irritation tests;
a non-irritant in Eye Irritation tests;
exhibit no mortality in Subchronic 14, 28 and 90 Day Oral Toxicity tests at dose levels of 5,000, 4,000, and 1250 ppm in diet respectively;
non-mutagenic or non-carcinogenic when handled using normal industrial hygiene practices in at least the polymerized state.

The disclosed polyurethane materials are more cross-linked or thermoset in nature than previously known biocompatible polyurethanes, which have, for the most part, been almost exclusively of a thermoplastic nature. As such, components and devices formed of the disclosed polyurethanes can exhibit improved properties during use including improved resistance to wear, improved resistance to permanent deformation and improved resistance to fatigue-induced failure.

For example, during start-up from resting and/or under less than optimal lubrication conditions, the interface temperatures of polyethylene total joint replacement materials has been found to exceed 60° C. Typical thermoplastic-type polyurethane materials examined for use in biomedical applications in the past, however, have generally been evaluated for hardness and deformation resistance at room temperature (ca. 22° C.) or only up to physiological temperature (ca. 37° C.). This is not surprising, as previously known thermoplastic-type biocompatible polyurethane materials can experience a decrease in hardness and/or modulus at increasing temperature, and can suffer permanent deformation under stress spikes due to a variety of typical in vivo conditions, such as high start up frictions. When considering the presently disclosed biocompatible polyurethane materials, which exhibit a more thermoset nature, such deformation and associated wear problems can be reduced, and the materials can exhibit improved long-term endurance and wear properties.

In spite of their more thermoset-like nature and due to their unique chemistry, the polyurethane materials of the present invention can be synthesized according to processes generally acceptable for softer, more thermoplastic type materials. For example, the disclosed materials can, in one embodiment, be formed via a two-step reaction process. This is not a requirement of the invention, however, and in other embodiments a one-shot or one-step formation process, as is generally known in the art, can be utilized. According to the two-step method, soft-segment diols can be reacted with excess di-isocyanate resulting in an isocyanate-terminated prepolymer. The prepolymer can then be further reacted with chain extenders in a second step to form the higher molecular weight product polymer. In particular, excess isocyanate relative to hydrogen allows for further cross-linking at elevated curing temperatures in the second step. Following addition of the chain extender, the material can be thoroughly mixed and shaped prior to final cure. The two step method of formation allows introduction of the chain extenders of the present invention in a controlled fashion that can, in some embodiments, further benefit the physical properties of the products.

Through polymerization of the chain extenders of the present invention with the above-described prepolymers and, it is believed, in particular due to the side reactions of the chain extenders during polymerization, a biocompatible polyurethane material can be formed exhibiting more thermoset-like behavior than polyurethane materials utilized in implantable devices in the past.

The products of the disclosed invention exhibit excellent wear characteristics due, it is believed, to the balance obtained between a high level of cross-linking from the side reactions that provide good structural recovery with the elastic modulus of the materials, while not forming too many cross-links, which could overly restrain molecular motion in the products and prevent desired elastomeric behavior.

The products of the present invention can exhibit a swelling ratio in a suitable solvent in the range of from about 2 to about 4, for instance from about 2.8 to about 3.4. For comparison purposes, slightly or non cross-linked thermoplastic materials generally exhibit a swelling ratio between 5 and 10, while highly cross-linked, very rigid thermoset materials have a swelling ratio less than 1.

The disclosed materials can have excellent characteristics for use in an implantable device, and in one particular embodiment for use in an implantable load-bearing device. For example, in a load-bearing device, the disclosed polyurethane materials preferably have a Shore D hardness of greater than about 60 and in particular in a preferred range between about 60 and about 85. In a more preferred range, the materials have a Shore D hardness of between about 65 and about 85. In some applications requiring greater hardness, the disclosed materials preferably have a Shore D hardness of greater than about 70.

Biocompatible stabilizers, fillers, including functional fillers, and other additives can also be included in the disclosed polyurethane materials. The addition of stabilizers or similar functional additives or fillers are generally known in the art. For example, fillers, and in particular functional fillers have been utilized in polyurethane materials in the past to help maintain physical properties of aliphatic hard segments over time or to decrease discoloring in aromatic hard segments. Accordingly, such biocompatible materials can likewise be incorporated into the disclosed polyurethane materials in suitable incorporation processes as are generally known in the art.

In one embodiment, functional fillers can be incorporated into the polyurethane materials. Enhancing certain characteristics of the materials can be accomplished in certain embodiments through the addition of functional fillers (such as lubricants) that can, for example, reduce frictional heat and decrease wear in implantable joint applications. Lubricant fillers can include fluorocarbon, silicone, polyethylene, carbon graphite, aromatic polyamide, and similar materials known in the art. The addition of functional fillers to the materials can also improve efficiency of processing as well as improve performance characteristics of the products. For example, in one embodiment a biocompatible functional filler, such as a thermally stable silicon compound or polyethylene particles, can be incorporated into the polyurethane prior to addition of the chain extender. More particularly, in the present invention, functional fillers that can be included in the formulation with limited reduction to or even enhanced mechanical properties shown in the final materials upon addition of the functional filler can be selected and incorporated in the materials. For instance, in one embodiment, a functional filler including polymeric particles that include surface reactive groups that can chemically react and bond to the polymer matrix after cure can be utilized. For example, in one particular embodiment, ultra-high molecular weight polyethylene particles with reactive groups at the particle surface can be incorporated to the formulation as a functional filler.

Optionally, a small amount of a cross-linking agent can be incorporated into the polyurethane materials. For example, in one embodiment, the polyurethane material can include between about 1wt % and about 10 wt % of a traditional cross-linking agent, for example a tri-functional component such as a triol can be utilized as is generally known in the art. A small amount of trifunctional soft segments can increase the total cross-linking of the disclosed materials.

According to one embodiment of the presently disclosed process, the second step of a two-step formation process, including the mixing of the prepolymer material with the curative/chain extender, can be carried out at a temperature greater than about 100° C., so as to encourage the side reactions resulting in cross-links and associated branching of the polymers. For example, in one embodiment, the second step can be carried out at a temperature of between about 100° C. and about 150° C.

In certain embodiments of the present invention, the final curing of the product polymers can be fairly rapid. As such, in some embodiments, direct molding of the product polymers can be utilized. In another embodiment, molding under compression forces may be used. In other embodiments, the materials can be formed to desired product dimensions following curing. For example, the materials can be machined to final product dimensions according to standard processes.

The invention may be better understood with reference to the following examples:

### EXAMPLE 1

Polymer Synthesis

Polyurethanes were synthesized in a two-step reaction; the first step consisting of the di-isocyanate (DI)—diol reaction, and the second consisting of the isocyanate terminated diol (referred to as prepolymer)—curative reaction, in which a functional filler was also added in some formulations. Reagents used, sources of reagents, and annotations used in the example section are summarized below in Table 1.

TABLE 1

| Reagent Type | Chemical or Trade Name | Annotation |
|---|---|---|
| Di-isocyanate | Toluene di-isocyanates | TDI |
| | 4,4′-methylene bis(phenyl | MDI |
| | isocyanate) | |
| Diol | Poly (ether) diol; obtained | TBI |
| | as TDI terminated prepolymer | |
| | (available from T-G Medical | |
| | Inc., Burlington, ON, Canada) | |
| | Aliphatic poly (carbonate) | PC-1667 |
| | diol; PC-1667 (available | |
| | from Stahl, USA of Peabody, | |
| | MA) | |
| | Aliphatic poly (carbonate) | PC-1733 |
| | diol; PC-1733 (available | |
| | from Stahl, USA) | |
| | C36 Dicarboxylic Dimer Diol; | Pripol 2033 |
| | Pripol ® 2033 (available | |
| | from Uniquema, of Newcastle, | |
| | DE) | |
| Chain Extender | Trimethylene glycol di-p- | VL |
| | aminobenzoate; Versalink ® | |
| | 740 | |
| | Dimethylthiotoluene diamine; | ET |
| | Ethacure ® 300 | |
| | 1-4 Butane Diol (available | BD |
| | from Sigma-Aldrich Corp., | |
| | of St. Louis, MO) | |
| Solid functional | Particulate polyethylene | Numerical values |
| filler | (60 μm), surface reactive | equivalent to % |
| | with polyurethane, trade | (w/w) solid filler |
| | named Primax ® UH 1250 | |
| | (available from Air | |
| | Products of Allentown, PA) | |

Formulations including MDI utilized freshly distilled MDI (using a standard laboratory vacuum-distillation set up). TDI was found to be of sufficient purity to use as received from the manufacturer. The DI was transferred into a clean, dry 1000 ml three-neck round bottom flask with side arms, which was assembled in the following manner:

1) The central neck was fitted with a Teflon stirrer bearing and metal stirring rod with half moon paddle. No lubricant was used between the stirrer bearing and the metal stirring rod. The stirring rod was then attached to a flexible shaft (Ace Glass Inc., Part # 8081-30), which was attached to the mechanical stirrer.

2) A side neck was connected to the gas system; the flask atmosphere was replaced with inert gas (N₂ or Ar) and positive inert gas pressure was applied throughout the remainder of the reaction.

3) A 250 ml dropping funnel containing the diol and wrapped with heating tape was fitted into the third neck. An oil bath, which was placed on a combination hot plate/magnetic stirrer, was raised underneath the 3-neck flask. The reaction vessel was flushed as necessary to replace air with inert gas.

Under mechanical stirring, the diol was either added drop wise over a period of several hours or introduced into the reaction flask by applying a small positive pressure of inert gas, which pushed the diol liquid through a plastic tube to the reaction flask. The soft-segment diol was reacted with the di-isocyanate in an approximately 2.05-2.1:1 ratio in all samples. After completion of the addition, the reaction was allowed to stir for approximately (30-60) minutes following which the contents of the flask were transferred into two previously massed wide mouth polyethylene bottles.

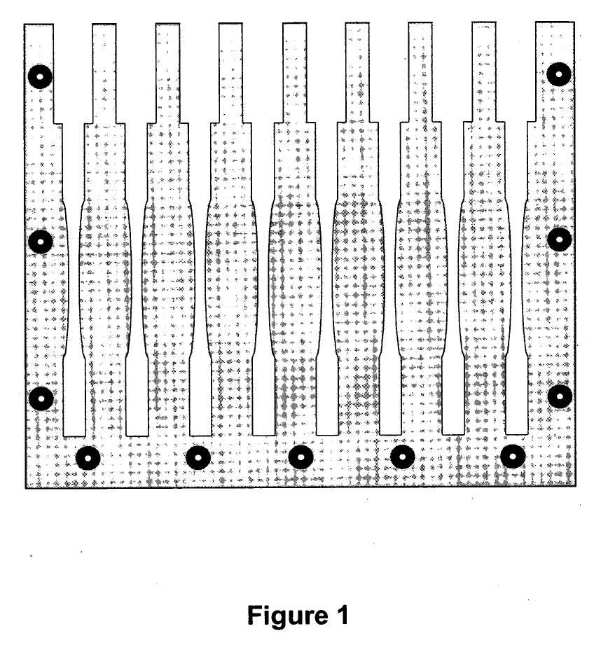

A mold was designed and fabricated to produce dumbbell shaped specimens for mechanical testing with dimensions specified in ASTM D 638-97 (FIG. 1) and also to concurrently produce 1.00 inch×3.00 inch rectangular specimens for use in wear testing. The mold was designed to produce specimens with a thickness of 7.0 mm.

The mold was assembled and heated for several hours in an oven held between about 100° C. and about 150° C. (referred to as the high temperature oven). A portion of prepolymer was heated in a second oven set to ≦100° C. (referred to as the low temperature oven) such that the viscosity became low enough that the prepolymer could be mixed by shaking, with the temperature dependent on the initial viscosity of the prepolymer.

In those samples including a solid functional filler, the massed portion of the filler was added to the heated prepolymer, which was mixed thoroughly by shaking and reheated in the low temperature oven again to a viscosity at which it could be mixed via shaking.

The prepolymer mixture, which, in some samples included a solid functional filler, was then removed from the low temperature oven and a stoichiometric amount of chain extender curative (pre-melted when necessary) was added, mixed via vigorous shaking, and poured into the hot mold. The mold was returned to the high temperature oven and the polymer in the mold was cured between 100° C. and 150° C. for (16-24) hours, at which point it was cooled to room temperature and disassembled.

### EXAMPLE 2

Prior to testing, four measurements of the width and thickness of the gauge length of each dumbbell shaped specimen were taken with a digital micrometer and recorded. Testing was performed at ambient room temperature using an Instron servohydraulic-testing machine (Model 8874, Instron Corp, Canton, Mass.) equipped with a 5 KN load cell. The ends of the specimens were gripped by servohydraulic grips; preliminary tests indicated a grip pressure of 20-30 bar to be optimal. Instron Fast Track, Version 3.4 (Instron Corp, Canton, Mass.) interface software controlled testing while output was recorded using Instron Max 32, Version 6.3 (Instron Corp, Canton, Mass.) software. Uniaxial tension tests were performed on at least 4 specimens of each formulation; different batches of the same formulation were also tested to investigate batch-to-batch variability. For each specimen, calculations were performed on selected subsets of data representing the maximum linear portion of the stress/strain curve prior to plastic deformation using commercial spreadsheet software (Microsoft Excel, Microsoft Corp., Redmond, Wash.), yielding tensile strength at yield and modulus of elasticity values, which were averaged for each formulation and/or batch.

Average elastic moduli, tensile strength at yield and Shore D hardness for samples tested are shown below in Table 3.

TABLE 3

| | Modulus of | | Tensile | | | | |
|---|---|---|---|---|---|---|---|
| | Elasticity | | strength | | | | |
| | (MPa); | Std. | at yield, | Std. | | Std. | Hardness |
| Formulation | r² > .95 | Dev. | avg. (MPa) | Dev. | % Elongation | Dev. | (Shore D) |
| TDI/Pripol/ | 594 | 8.9 | 50 | 1.5 | 44 | 4.9 | 75 |
| VL/2.5 | | | | | | | |
| TDI/Pripol/ | 525 | 16.2 | 38 | 1.0 | 44 | 5.2 | 73 |
| ET/2.5 | | | | | | | |
| TDI/PC1733/ | 283 | 7.8 | 25 | 0.4 | >180 | — | 66-70 |
| VL/2.5 | | | | | | | |
| TDI/PC1733/ | — | — | 44-45 | — | 70-140 | — | 75-77 |
| VL/BD1.5/4 | | | | | | | |
| TDI/PC1733/ | — | — | 51-55 | — | ≦50 | — | 80-84 |
| VL/BD2.2/4 | | | | | | | |
| TBI/VL/2.5 | 252 | 22.7 | 22 | 0.6 | >180 | — | 62-66 |
| TBI/ET/2.5 | 221 | 5.4 | 22 | 0.2 | >180 | — | 67 |

### EXAMPLE 3

A polyurethane formulation based on TDI/PC1733/VL was prepared with either 6.8% NCO (w/w) or 7.2% NCO (w/w) in the prepolymer. The prepolymer formulations were then mixed with various amounts of the solid functional filler (i.e., 0%, 2.5%, 6.0%, or 10% (w/w) before final polymerization with the VL chain extender/curative. Average elastic moduli, % elongation, energy at break and tensile strength at yield for samples tested are given in Table 4. Samples had dimensions of ASTM D638 Type-I and were tested at strain rate of 50 mm/sec on an Instron testing machine (4500) and tensile yield strengths were calculated by the Instron software, version 1.11 .Table 4.

TABLE 4

| | | | | | | | 2% | |
|---|---|---|---|---|---|---|---|---|
| | Modulus of | | % | | Energy | | Yield | |
| | Elasticity | Std. | Elong. | Std. | at Break | Std. | Strength | Std. |
| | (MPa) | Dev. | (%) | Dev. | (J) | Dev. | (Mpa) | Dev. |
| 6.8 NCO_0% | 205 | 19.6 | 476 | 27.0 | 450 | 36.7 | 15.9 | 1.1 |
| 6.8 NCO_2.5% | 186 | 9.0 | 217 | 113 | 156 | 97.5 | 14.6 | 0.4 |
| 6.8 NCO_6% | 284 | 2.0 | 362 | 118 | 349 | 142 | 19.7 | 0.2 |
| 6.8 NCO_10% | 223 | 20.0 | 288 | 96.4 | 222 | 97.8 | 16.1 | 0.8 |
| 7.2 NCO_0% | 296 | 53.7 | 447 | 71.4 | 523 | 99.7 | 24.0 | 1.2 |
| 7.2 NCO_2.5% | 286 | 9.6 | 521 | 55.5 | 597 | 85.4 | 21.3 | 0.6 |
| 7.2 NCO_6% | 317 | 4.5 | 446 | 52.8 | 497 | 78.8 | 22.8 | 0.4 |
| 7.2 NCO_10% | 274 | 14.2 | 507 | 57.1 | 548 | 82.0 | 19.4 | 0.6 |

### EXAMPLE 4

Bearings were prepared including an upper bearing surface of stainless steel and a lower bearing surface of various polymeric materials. Specifically, polyurethane formulations of TDI/PC1733/VL samples containing 0%, 2.5% and 6% solid functional filler were cast into a mold and samples in the shape of 1 inch×3 inch×7 mm plaques were formed. UHMWPE (GUR 4150) samples were machined to the same dimensions for comparison purposes. In particular, the disclosed polyurethane materials were compared to control samples formed from UHMWPE, as possible comparative medical grade polyurethane polymers for orthopedic bearing applications are not generally used or commercially available. Four plaques of each formulation were selected based on uniform surface features, cleaned, and conformed to specified dimensions. The plaques were weighed and the masses were recorded.

A sliding path geometry which traces a 5-pointed star shape pattern was chosen for wear testing as such a pattern can accommodate five measurements each of start-up friction and crossing points per cycle. Each of the five lines comprising the star pattern was 20 mm in length. At each star point, the machine was programmed to pause for 200 milliseconds, then accelerate at 250 mm/sec to a constant velocity of 50 mm/sec. The length of the contact pathway per cycle was 100 mm, and the calculated time per cycle was 4.00 sec.; accordingly a 10 km test took approximately 5 days of continuous cycling. This wear pattern was programmed into the software, which also allowed for periodic measurement of friction.

The plaques were examined with a Wyko NT-2000 Optical Profiler; surface profiles were taken at the locations on the plaque that corresponded to the five areas of cross-shear to be examined. The roughest plaque of each formulation to be tested was used as soak control.

50 ml of 50% bovine serum (+0.2% NaN₃ anti-microbial agent) was added to each of six stations of the wear testing machine, each of which contained an individual plaque, and evaporation barriers were secured. Soak controls were immersed in serum and placed in an environment with a constant temperature of 37.0° C. The serum in the stations was allowed to warm to 37.0° C. before wear testing was started. Fluid levels were checked periodically and were topped up with distilled, deionized water as required, and friction measurements were taken periodically.

Experiments were run to over 100,000 cycles corresponding to a total distance of 10 km. Soak controls and wear samples were removed from heat, allowed to cool and were cleaned by sonication in 1 % Liquinox for 20 minutes followed by three separate 15 minute sonications in fresh DI water and finally dried under vacuum. Following the wear test, dry samples were reweighed and were examined with the profilometer at the points predicted by the co-ordinate system, or at the actual points of cross shear if the predictions proved inaccurate. Other surface profiles were taken along the wear track, and masking and volumetric reconstruction was performed on the cross shear points and linear contact paths to determine the natural volume required to fill the damage track to the original level of the undamaged surface. The accuracy of the reconstruction calculations performed by the profilometer software was verified for the first specimens using simple geometric calculations and averaged wear track dimensions.

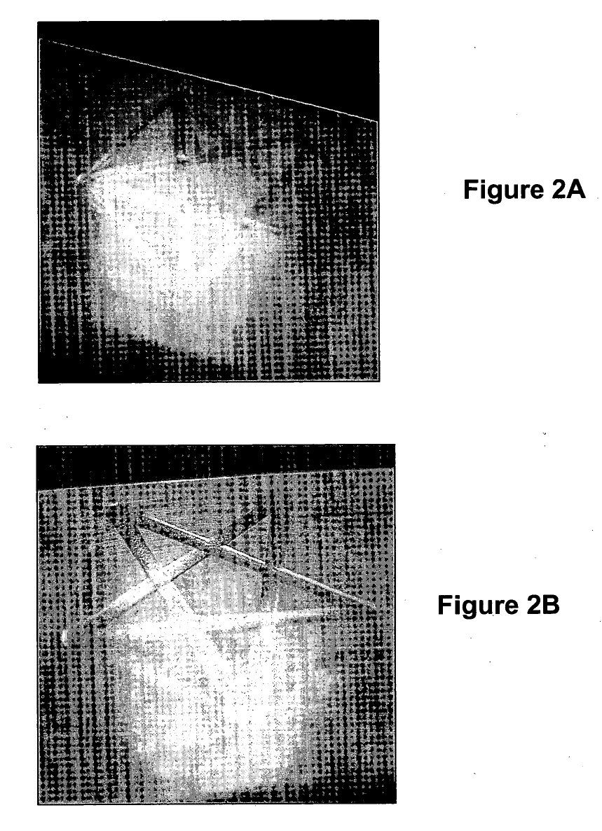

Friction measurements were taken approximately every 2 km of path length. Serum levels were maintained through periodic addition of distilled, deionized water as necessary, and serum levels never dropped below the threshold of dryness between the bearing surfaces. Visual examples of damage tracks can be seen in FIGS. 2A and 2B. FIG. 2A illustrates the star shaped damage track on UHMWPE sample, shown magnified at 12×; FIG. 2B illustrates the same on a polyurethane sample. Accelerated wear or damage at crossing (within the star pattern) points and at stopping points (at the tips of the star pattern) is considered indicative of a material's potential for failure under cross-shear conditions, an important failure mode for existing materials currently used in orthopedic bearings.

Two wear studies were performed: one under load normalized (low stress) conditions, and one under stress normalized (high stress) conditions. Inclusion of the stress normalized condition provided a test of the polyurethane formulations under extreme conditions with particular respect to orthopedic applications.

Scans were taken of the five cross shear points and a random linear portion of each of the five lines of the star pattern. A masking procedure was used to isolate only the region of the damage track using the edge of the flat sample surface at which damage began. The volume required to fill the damage track to the level of the undamaged surface, or “natural volume” of that region was calculated, and the length of the track region being assessed was recorded. For cross-shear areas, which after masking have the shape of a parallelogram with sides nearly equal, the two track lengths were recorded and averaged. The natural volume was then normalized to length of track, to give average volume of damage per unit of track length for both linear and cross shear areas of the damage track. The comparison between normalized volume loss in linear regions to normalized volume loss in cross shear regions in the same sample can be expressed as a ratio. However, since the regions under cross shear have experienced twice as many contact cycles as corresponding linear damage track regions, the ratio is appropriately expressed as the quotient of the normalized volume loss in cross shear regions divided by twice the normalized linear volume loss.

The average ratios for each specimen are given for UHMWPE in Table 5 and for the polyurethane formulations in Table 6. For each specimen in Table 5 and Table 6, values listed were calculated using average of the five cross shear points on that specimen, or the average of a total of five sections of linear damage track (one from each of the five lines comprising the star shape) as appropriate.

TABLE 5

| | Adjusted Linear: |
|---|---|
| Specimen, station | Cross Shear Ratio |
| UHMWPE | |
| UHMWPE, 2 | 1.04 |
| UHMWPE, 4 | 1.45 |
| UHMWPE, 6 | 1.92 |
| AVERAGE | 1.47 |
| STD. DEV. | 0.52 |

TABLE 6

| | Adjusted Linear: |
|---|---|
| Specimen Station | Cross Shear Ratio |
| PU, 0% Filler, Stress Normalized | |
| 1 | 0.70 |
| 3 | 0.42 |
| 5 | 0.34 |
| AVERAGE | 0.49 |
| STD. DEV. | 0.19 |
| PU, 2.5% Filler, Stress Normalized | |
| 2 | 0.36 |
| 4 | 0.10 |
| 6 | 0.03 |
| AVERAGE | 0.16 |
| STD. DEV. | 0.17 |
| PU, 0% Filler, Load Normalized | |
| 2 | 0.32 |
| 4 | 0.70 |
| 6 | 0.42 |
| AVERAGE | 0.48 |
| STD. DEV. | 0.20 |
| PU, 6% Filler, Load Normalized | |
| 1 | 0.54 |
| 3 | 0.76 |
| 5 | 0.36 |
| AVERAGE | 0.55 |
| STD. DEV. | 0.20 |

The average cross shear: linear damage ratio of 1.47 for UHMWPE indicates that damage in cross shear areas is accumulating at approximately 3 times the rate that linear wear is. In a “simple” material, exhibiting the same damage rate in both linear and cross shear damage areas and at a rate that is proportional to the number of contact cycles, the ratio would be 1.0 (although the surface damage in cross shear areas would be doubled, the number of effective contact cycles is also doubled). A ratio of 1.47 indicates that UHMWPE is failing under cross shear at a rate higher than might be expected and implicates a different mechanism for damage under cross shear conditions than in linear contact pathways. Accelerated failure of UHMWPE at the cross shear points is clearly visible in the low magnification photograph shown in FIG. 2A. Thus, the test demonstrated that damage under crossing contact pathways is a possible failure mechanism for UHMWPE and has significant implications for applications such as orthopedic bearings in which materials will be subject to wear under similar conditions.

The average cross shear:linear damage ratios for the polyurethanes ranged from 0.16 to 0.55, consistently and substantially less than the 1.0 ratio of the “simple” material. A cross shear:linear ratio of less than 1.0 would indicate that such a material, consistent with the predicted behavior of the polyurethane formulations in the current disclosure, may not experience the same kind of accelerated failure as UHMWPE could in applications in which it is subjected to significant cross-shear kinematics.

SEM Analysis

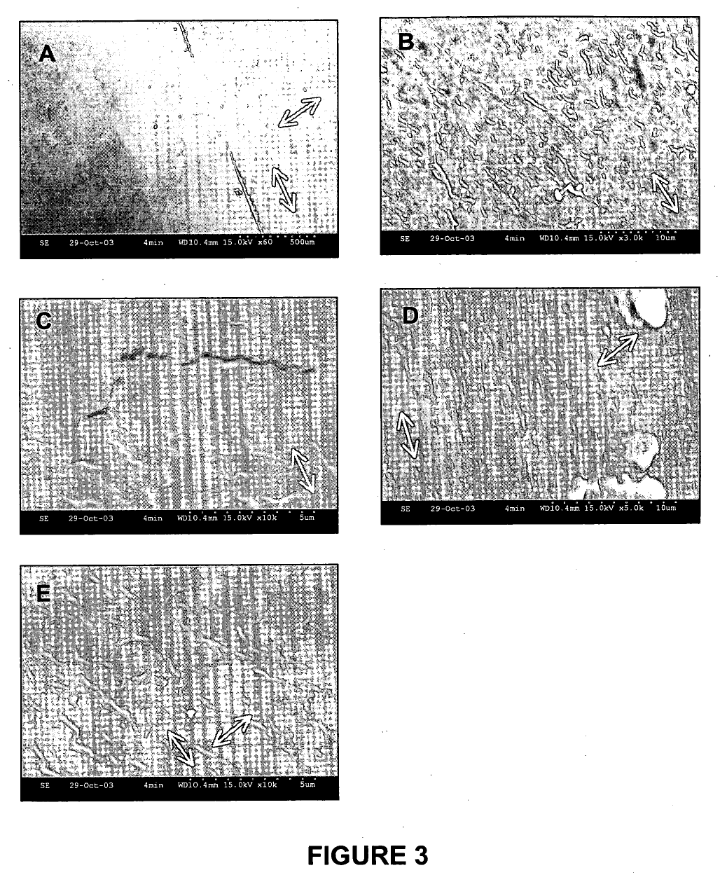

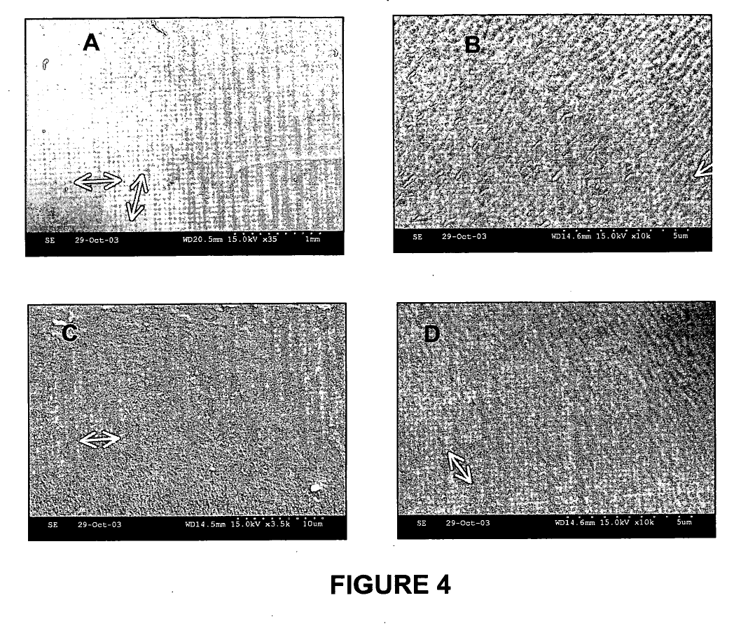

A specimen from each test was gold coated to enhance visibility for scanning electron microscopy. The coating was applied with a Denton Vacuum Desk II Gold Coater at 25 milliamps for 3 minutes under a vacuum of approximately 50 millitorr. Gold-coated samples were analyzed with a Hitachi S-3500N Scanning Electron Microscope using SEM Software Version 03-03 and PC Software Version 03-04-0370. Representative scans of undamaged polymer surface, damage in linear portions of contact pathways, and damage in cross shear areas of each specimen were taken. FIGS. 3A-3E are SEM images of UHMWPE samples, and FIGS. 4A-D are SEM images of polyurethane samples.

The surface outside of the damage tracks on the UHMWPE sample (FIGS. 3A-3E) was characterized by fibrils which were visible at magnifications between 5,000× and 10,000× and tended to be oriented in an up-down direction relative to the screen. The surface had parallel scratches, possibly an artifact from conditioning with the Poly-Cut diamond knife. A low magnification of the surface, showing a cross shear area of a damage track and a significant portion of undamaged surface is shown in FIG. 3A.

The polyethylene surface inside the linear portion of the damage track was consistently characterized by fibrils aligned parallel to the orientation of the damage track as seen in FIG. 3B. Evidence of surface damage and fracture within the wear track was also present (FIG. 3C).

The surface inside the cross shear portion of the damage track was noticeably different than in the damage track. In the areas of cross shear closest to the linear damage tracks, where it appeared the slope was steeper, a cobblestone appearance was visible as shown in FIG. 3D. The ridges of the cobblestone lines were perpendicular to the orientation of the two linear damage tracks. Closer to the middle of the cross shear area the texture changed and was dominated by larger fibrils that appeared somewhat smeared, as shown in FIG. 3E.

The surface outside of the damage tracks on the filler-free polyurethane sample (FIGS. 4A-4D) was characterized by slight bumpiness that was visible at magnifications between 5,000× and 10,000× and tended to be random in orientation. Circular ridges from the mold surface were visible on the undamaged surface of the polymer. A low magnification of the surface, showing a cross shear area of a damage track and a significant portion of undamaged surface is shown in FIG. 4A.

The filler-free polyurethane surface inside the linear portion of the damage track was consistently characterized by ridges aligned perpendicular to the orientation of the damage track as seen in FIG. 4B. The wear track surface was quite uniform and evidence of other damage modes was not visible. The transition from the bumpy undamaged polymer surface (top) to the wear track with perpendicular ridges (bottom) can be seen in FIG. 4C.

The surface inside the cross shear portion of the damage track was similar in appearance to the linear damage track. The appearance was consistently dominated by ridges aligned in a direction perpendicular to the closest (dominant) linear wear track. The direction of the ridges changed only gradually as the dominant linear wear track did, and in no single picture at a resolution capable of showing ridges could a clear transition or change of direction be found. The ridges, although similar in both appearance and alignment to those in the linear damage track, were smaller as evident in FIG. 4D. The cross shear ridges were between one half and two thirds as big as the wear track ridges.

The majority of the surface area of the polyurethanes with filler was similar in appearance and behavior to the polyurethanes without filler. Noticeable differences were centered around the presence, or absence, of filler particles within the polyurethane matrix.

The polyurethane specimens appear to have very similar damage mechanisms in cross shear and linear regions. Both regions were consistently characterized by wavy ridges aligned perpendicular to the direction of the contact pathway. The whole of the cross shear area had the same appearance, with the ridges gradually changing direction to maintain perpendicular orientation with respect to the closest linear damage track. The only noticeable difference was that ridges in the cross shear area were smaller than those in the linear track by a factor of one third to one half. The similarities between cross shear and linear wear imply a consistent damage mechanism in the two locations, and lend support to the hypothesis generated from the profilometric analysis that a damage mechanism that has approached a threshold in both locations may have been acting to create less cross shear damage than expected, resulting in a cross shear: linear damage ratio less than 1.

### EXAMPLE 5

Knee simulator testing was performed on custom fabricated tibial plateaus made from the disclosed polyurethanes. A four station Stanmont/Instron force controlled knee wear testing simulator was used, and the experimental tibial plateaus were articulated with scratched femoral components, representing adverse testing conditions. A HEPU formulation based on TDI/PC1733/VL that did not include any filler was run in a 1 million-cycle test, and compared with a similar formulation containing filler incorporated at a level of 4%. The formulation with functional filler averaged 53 mg HEPU wear (volume equivalent of 40 mg UHMWPE wear) while the other formulation, without filler, averaged 277 mg HEPU wear (volume equivalent of 211 mg UHMWPE wear). Thus, in this case, the addition of the functional filler appeared to improve the wear characteristics of the HEPU.

In a 2 million cycle test, a HEPU formulation based on TDI/PC1733/VL with a Shore D hardness of 70/72 D was compared with a HEPU formulation based on TDI/PC1733/VL/BD with a Shore D hardness of 75/77 D, where both formulations had functional filler incorporated at 4%. The harder formulation averaged 84 mg HEPU wear per million cycles (volume equivalent of 64 mg UHMWPE wear) while the other formulation averaged 167 mg HEPU wear per million cycles (volume equivalent of 127 mg UHMWPE wear). Thus, in this case, the harder HEPU polymer exhibited improved wear characteristics.

An additional million cycles of wear on samples from the harder (75/77 D) formulation was performed, and the wear behavior improved compared to that shown in the previous period of wear. After a total of 3 million cycles, this formulation now averaged 73 mg HEPU wear per million cycles (volume equivalent of 56 mg UHMWPE wear).

### EXAMPLE 6

The effect of incorporating the functional filler described in Example 1 on the mechanical properties of TDI/PC1733/VL based formulations was evaluated. In a set of experiments designed for examining the effect, 2 wt % of functional filler was incorporated to half of the elastomer samples, and tensile properties were measured based on specimens having dimensions of ASTM D638 Type-IV. The comparison of results is shown in Table 7.

TABLE 7

| | | | Effect of |
|---|---|---|---|
| | TDI/ | TDI/ | functional |
| | PC1733/VL | PC1733/VL/2 | filler (% |
| | (no | (2 wt % | change from |
| | functional | functional | formulations |
| | filler) | filler) | without filler) |
| Elastic Modulus | 260 | 299 | +15 |
| Tensile Strength | 23.4 | 29.1 | +24 |
| at Yield | | | |
| Energy at Break | 20.6 | 37.6 | +83 |
| Elongation | 276 | 387 | +40 |
| at Break | | | |

As can be seen, in this formulation, the incorporation of 2 wt % of the disclosed functional filler can have a significant effect on the mechanical properties of the polyurethane polymers disclosed herein.

### EXAMPLE 7

Biocompatibility Testing—in vitro

Flat discs (approximately 15 mm diameter; 1.2 mm thickness) were fabricated from the polyurethane formulations as described in Example 1 and from an ultra-high molecular weight polyethylene (GUR 4150, Poly Hi Solidur) control. Following visual and microscopic inspection, the specimens were grouped by formulation and batch and cleaned. The specimens were sterilized via an ethanol dip procedure.

Synoviocytes (ATCC, #CRL-1832) were maintained in T-75 Falcon cell culture flasks (VWR, #2918-801) using sterile F12 (Ham) Nutrient Mixture (Sigma) with 10% F 4135 Heat Inactivated Fetal Bovine Serum (Sigma) and 1% Antibiotic Antimycotic Solution, 100× (Sigma) in a controlled environment at 37° C. and 5% CO₂ in air. Four discs each of four experimental polyurethanes (plus PE control) were placed in a random configuration at the bottom of 20 wells of a 24 well plate (Falcon) that had been tissue culture treated with vacuum gas plasma. Four of the wells were left blank as a positive control.

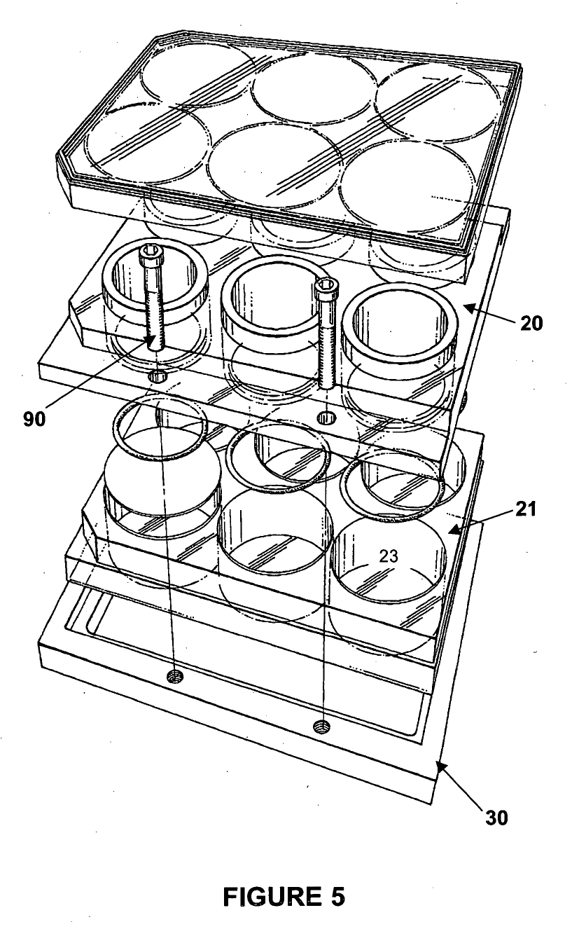

The apparatus, illustrated in FIG. 5, consisted of components including a base 30 and a well-plate 21, both of which were sterilized prior to use. The apparatus and its associated method of use are further described in U.S. Patent Application Publication No. US 2002/0182720, which is incorporated herein by reference. The well plate 21 containing the samples was placed in the base 30 and an insert 20 was fitted into each well 23 of the well plate 21. Compression applied between the insert and base, such as by pegs or bolts 90, secured the material samples to the bottom of the individual wells 23. The insert 20 allowed normal pipette access to each well 23.

Synoviocytes were seeded into each well 23 (5.0×10⁴ cells/well) and were incubated for 24 hours. An MTS (Promega, #G 3580) metabolic assay was then performed via calorimetric determination of the concentration of the formazan bioreduction product at 490 nm. Cells were then counted using a hemocytometer and Trypan Blue exclusion techniques, counting cells that do not take up the dye as viable and those taking up the dye as non-viable. Material samples were recovered by releasing the compression and removing the insert.

Disc shaped samples of four polyurethane formulations were prepared, cleaned and sterilized, and the synoviocytes were cultured on the biomaterial discs using the cell well apparatus. The results of the MTS assay and cell counts after culture for 24 hours are described in Table 8, below

TABLE 8

| | | | Normalized | |
|---|---|---|---|---|
| | Number | | MTS | |
| | of Cells | Std. | Absorbance | Std. |
| | (×1000) | Dev. | (490 nm) | Dev. |
| TISSUE | 11.4 | 2.6 | 3.1 | 0.1 |
| CULTURE | | | | |
| POLYSTRENE | | | | |
| (blank control) | | | | |
| TBI/VL | 8.5 | 4.0 | 3.3 | 0.4 |
| TBI/ET | 15.6 | 8.2 | 1.8 | 0.1 |
| TDI/PC1733/VL | 9.1 | 4.9 | 3.1 | 0.4 |
| TDI/PC1733/ET | 10.1 | 1.1 | 2.9 | 0.3 |
| UHMWPE | 3.2 | 0.3 | 7.4 | 0.6 |

It was observed that all four experimental polyurethane formulations behaved in a manner that was not statistically different than tissue culture polystyrene did with respect to cell population 24 hours after seeding, indicating that these materials provide a good surface for cell adhesion and proliferation. A similar trend was observed with respect to MTS metabolic activity, wherein three of the four polyurethane formulations stimulated metabolite levels that were not statistically different than those from the TCPS control.

Medical grade UHMWPE is an accepted negative control for cytotoxicity testing (for example ASTM F813 or ISO 10993-5), and also has significant relevance to materials being tested for orthopedic bearing applications. Medical grade UHMWPE was therefore tested along with the polyurethane formulations for comparison purposes. With statistical significance and a very tight standard deviation, the UHMWPE uniformly showed a compromised ability to support cell adhesion and growth, reflected in cell populations 24 hours after seeding, as compared to TCPS. This is a predictable observation based on known cellular response to hydrophobic, smooth materials—polyethylene is not a preferred substrate for cell culture. UHMWPE also displays significantly higher normalized MTS metabolic activity compared to both TCPS and the four polyurethane formulations. Since the behavior of cell populations on TCPS is considered normal behavior of cells in culture, deviation from this, whether high or low, is typically not desirable during evaluation of toxicity and biocompatibility.

Biocompatibility Testing—in vivo

Two polyurethane formulations, based on TDI/PC1733/VL and TBI/ET and each having a constant 2.5% w/w level of solid filler, and polyethylene (from GUR 4150 stock bar), were fabricated into bullet-shaped cylindrical implants having dimensions of 3.5 mm×10 mm.

Six implants of each formulation were scrubbed using pure ethanol to solvate any grease from the fabrication process. They were then individually placed in disposable sterile centrifuge tubes, sonicated in ethanol for 6 hours and left to soak for an additional 10 hours. Following removal and drying, roughness measurements were taken of each sample type using the non-contacting surface profilometer. The implants were then vigorously cleaned with Liquinox. The implants were placed in water in sterile specimen containers and soaked at 37° C. for 48 hours to remove any unreacted isocyanates. The implants were then cleaned by sequential ultrasonic cleaning of the implants in isopropyl alcohol (20 min), 1 % aqueous Liquinox solution (20 min.), and 3 cleanings in fresh ultra pure deionized water (15 min. each). After examination under a stereomicroscope they were individually bagged for ethylene oxide sterilization and were labeled and numbered. They were then sterilized with ethylene oxide, degassed, and transferred to a vacuum dessicator.

Four implants of each formulation, and two medical grade UHMWPE control implants were formed. One implant was placed in the femur of each of the ten mature New Zealand White Rabbits. Rabbits F2, F4, F6 and F8 received implants from the TDI/PC1733/VL formulation; rabbits F3, F5, F7 and F9 received implants from the TBI/ET formulation, and rabbits F1 and F10 received control UHMWPE implants. Each rabbit received one implant.

Four months (116 days) post-op, retrieval procedures were performed on the 10 rabbits. The retrieved implants and surrounded tissue were processed using standard hard tissue processing techniques. Histological slides were prepared from thin sections from the saggital plane of the knee that had been stained with Methylene Blue and Basic Fuchsin. Assessing the reaction of tissue to implant materials was achieved through histological evaluation of thin sections of the implanted bone that were stained to highlight cellular features. Based on semi-quantitative and qualitative analysis, the samples were matched to a simple histological grading scale as outlined in Jansen, et al. (Jahnsen, Dert, et al., 1993, which is incorporated herein by reference). Average Jansen scores for each formulation are shown in Table 9, and the grading scale for each of the four categories is given in Table 10.

TABLE 9

| | Bone | | | |
|---|---|---|---|---|
| | reaction, | Bone | | |
| | semi- | reaction, | Interface, | Interstice, |
| Implant | quantitative | qualitative | qualitative | qualitative |
| TDI/PC1733/VL | 4 ± 0 | 3 ± 0 | 4 ± 0 | 3.25 ± 0.5 |
| TBI/ET | 3.5 ± 0.6 | 2.75 ± 0.5 | 3.25 ± 0.5 | 3 ± 0 |

TABLE 10

| Reaction Zone | Response | Score |
|---|---|---|
| Bone reaction, | Thickness Rating (mm): | |
| semi - | 0-50 | 4 |
| quantitatively | 51-250 | 3 |
| | 251-500 | 2 |
| | >501 | 1 |
| | Not applicable | — |
| Bone reaction, | Similar to original cortical bone | 4 |
| qualitatively | Lamellar or woven bone with bone | 3 |
| | forming activity | |
| | Lamellar or woven bone with bone | 2 |
| | forming activity and | |
| | osteoclastic activity | |
| | Other tissue than bone (e.g. | 1 |
| | fibrous tissue) | |
| | Inflammation | 0 |
| Interface, | Direct bone-to-implant contact | 4 |
| qualitatively | without soft tissue | |
| | interlayer | |
| | Remodeling lacuna with osteoblasts | 3 |
| | and/or osteoclasts at surface | |
| | Localized fibrous tissue not | 2 |
| | arranged as a capsule | |
| | Fibrous tissue capsule | 1 |
| | Inflammation | 0 |
| Interstice, | Mature bone and differentiation | 4 |
| qualitatively | of bone marrow can be | |
| | observed in the interstitium | |
| | Bone formation can be observed | 3 |
| | in the interstitium | |
| | Tissue in interstitium consists | 2 |
| | of fibrous connective tissue | |
| | characterized by condensation | |
| | of collagen fibers at the | |
| | implant interface | |
| | Tissue in interstitium consists | 1 |
| | of fibrous connective tissue | |
| | with a pronounced cellular and | |
| | vascular component | |
| | Implant cannot be evaluated | 0 |
| | because of problems that | |
| | may not only be related to | |
| | the material to be tested | |

The averaged scores indicate an acceptable reaction for both of the polyurethane formulations, although the polycarbonate/trimethylene glycol di-p-aminobenzoate (TDI/PC1733/VL) combination graded slightly higher than the polyether/dimethylthiotoluene diamine (TBI/ET) did in all four categories. The lower score for TBI/ET may be attributed at least in part to randomly poorer placement with respect to proximal distance into the femur, on average, than the other formulations received. Placement which is too proximal results in altered loading conditions and micromotion between the implant and the surrounding tissue, and fibrous tissue is formed instead of a tight bone interface, depressing scores based on the criteria for evaluating hard tissue. The polyethylene was included as a control, but in insufficient numbers to attain statistical significance. All scores indicate all of these materials to be considered acceptably biocompatible.

It will be appreciated that the foregoing examples, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention that is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

What is claimed is:

1. A device comprising:
a polyurethane comprising the reaction product of:
a) a di-isocyanate monomer,
b) a soft segment monomer comprising terminal acidic hydrogens,
c) a chain extender comprising a terminal group capable of side reactions and further comprising an electron withdrawing group immediately adjacent the terminal group;
wherein the device is an implantable, biocompatible device.

2. The device of claim 1, wherein the di-isocyanate is an aromatic di-isocyanate.

3. The device of claim 1, wherein the soft segment is a polyol.

4. The device of claim 1, wherein the soft segment is a polyamine.

5. The device of claim 1, wherein the terminal group of the chain extender is a primary amine.

6. The device of claim 1, wherein the electron-withdrawing group of the chain extender is an aromatic group.

7. The device of claim 1, wherein the chain extender is an aromatic diamine.

8. The device of claim 1, the chain extender further comprising one or more substantially inflexible groups.

9. The device of claim 8, wherein the chain extender comprising one or more substantially inflexible groups further comprises hydrogen-bond forming moieties.

10. The device of claim 8, wherein the chain extender comprises two or more substantially inflexible groups, the inflexible groups being linked with a C1- C8 substituted or unsubstituted aliphatic chain.

11. The device of claim 1, wherein the soft segment includes a linking segment selected from the group consisting of a polycarbonate, a dimer acid, a polyester, and a polyether.

12. The device of claim 1, wherein the soft segment is a polycarbonate or a polyether.

13. The device of claim 1, wherein the chain extender is dimethylthiotoluene diamine.

14. The device of claim 1, wherein the chain extender is an ester of p-aminobenzoic acid.

15. The device of claim 1, wherein the implantable device is an orthopedic device, a vascular device, a shunt, a catheter, a spinal implant, or a reconstructive device.

16. The device of claim 1, wherein the polyurethane further comprises a filler.

17. The device of claim 16, wherein the filler is a functional filler.

18. The device of claim 17, wherein the functional filler comprises polymeric particles.

19. The device of claim 1, wherein the polyurethane describes a Shore D hardness greater than about 60D.

20. A device comprising a polyurethane of the general structure: 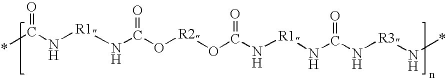
wherein:
R1 is aromatic or aliphatic,
R2 is aromatic or aliphatic,
in the —NH—R3NH— segment, R3 comprises one or more electron withdrawing groups, wherein an electron withdrawing group is immediately adjacent each of the nitrogens of the segment;
wherein the device is an implantable, biocompatible device.

21. The device of claim 20, wherein R3 comprises only one aromatic electron withdrawing group.

22. The device of claim 21, wherein R3 comprises two or more substituted or unsubstituted aromatic rings linked with a C1-C8 substituted or unsubstituted aliphatic chain.

23. The device of claim 20, wherein R2 is selected from the group consisting of a polycarbonate, a dimer acid, a polyester, and a polyether.

24. The device of claim 20, wherein R2 is a polycarbonate or a polyether.

25. The device of claim 20, wherein the —NH—R3—NH— segment is the residue of dimethylthiotoluene diamine.

26. The device of claim 20, wherein R3 comprises the general structure:

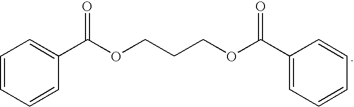

27. The device of claim 20, wherein the polyurethane further comprises a functional filler.

28. The device of claim 27, wherein the functional filler is ultrahigh molecular weight polyethylene.

29. The device of claim 27, wherein the functional filler is a lubricant.

30. The device of claim 20, wherein the polyurethane has a Shore D hardness greater than 60.

31. A device comprising an implantable, biocompatible load-bearing polyurethane portion, the polyurethane comprising the reaction product of:
a) a di-isocyanate monomer,
b) a soft segment monomer comprising terminal acidic hydrogens,
c) a chain extender comprising a terminal group capable of side reactions and an electron withdrawing group immediately adjacent the terminal group and
wherein the device is an implantable artificial joint or an artificial intervertebral disc.

32. The device of claim 31, wherein the di-isocyanate is an aromatic di-isocyanate.

33. The device of claim 31, wherein the soft segment is a polyol.

34. The device of claim 31, wherein the chain extender is an aromatic diamine.

35. The device of claim 31, wherein the soft segment is a polycarbonate or a polyether.

36. The device of claim 31, wherein the chain extender is dimethylthiotoluene diamine.

37. The device of claim 31, wherein the chain extender is an ester of p-aminobenzoic acid.

38. The device of claim 31, wherein the artificial joint is an artificial hip joint.

39. The device of claim 38, wherein the polyurethane portion comprises the acetabular cup of the artificial hip joint.

40. The device of claim 31, wherein the artificial joint is an artificial knee joint.

41. The device of claim 40, wherein the polyurethane portion comprises the tibial plateau of an artificial knee joint.

42. The device of claim 31, wherein the polyurethane further comprises a functional filler.

43. The device of claim 41, wherein the functional filler is ultra-high molecular weight polyethylene.
